(19) United States
(12) Patent Application Publication
(10) Pub. No.: US 2026/0237928 A1
(43) Pub. Date: Aug. 13, 2026

(54) Connector Pin

(71) Applicant: TE Connectivity Solutions GmbH, Schaffhausen (CH)

(72) Inventors: Quentin DELESTRE, Pontoise (FR); Francois JODON DE VILLEROCHE, Pontoise (FR); Steven LORD, Pontoise (FR); Xavier ROUILLARD, Pontoise (FR)

(73) Assignee: TE Connectivity Solutions GmbH, Schaffhausen (CH)

(21) Appl. No.: 19/401,456

(22) Filed: Nov. 26, 2025

(30) Foreign Application Priority Data
Nov. 28, 2024 (FR) FR2413111

(51) Int. Cl. H01R 13/04

(52) U.S. Cl. CPC H01R 13/04

(57) ABSTRACT

The present invention relates to a connector pin comprising an electrically conductive elongated flat body and an electrically insulating element. At least one protrusion extends from a flat base of a frontal edge of the elongated flat body. The protrusion has a through opening. The electrically insulating element covers the front edge and the protrusion so as to fill the through opening. The main protrusion may have at least one trapezoidal section in a sectional plane parallel to the flat base of the front edge.

### CROSS-REFERENCE TO RELATED APPLICATION

This application claims the benefit of French Patent Application No. 2413111 filed on Nov. 28, 2024 in the French Patent Office, which is hereby incorporated by reference in its entirety.

### BACKGROUND OF THE INVENTION

The present invention relates to a connector pin, in particular to a connector pin having an elongated flat body, as well as to a connector element comprising a housing and a connector pin.

Electrical connector pins, and in particular flat pins, as well as connector elements, are often used to connect a vehicle's electrical system to its battery or accumulator. This applies in particular to electric or hybrid vehicles, which require the transmission of high currents and/or voltages through the connectors, and consequently, their pins.

Flat pins have advantages over round pins, including the ability to be inserted in two different directions or to be used in angled (90°) or straight (180°) connectors. On the other hand, round pins require different models for each type of connector, which increases the production complexity of the components.

Due to the high currents and voltages involved, the connectors must comply with the strict requirements of the standards, for example IPXXB and/or IPXXB+ standards.

These standards require that connector pins be protected from accidental contact with a human finger or a similar object. These standards are part of the IP (Ingress Protection) classification which defines the level of protection of equipment against the intrusion of foreign bodies and accidental contact. The IPXXB standard ensures that the contact elements are protected against accidental contact with objects of similar size to a human finger, for example a standard test finger with a diameter of 12 mm and a length of 80 mm. The IPXXB+ standard is a reinforced version of the IPXXB standard, providing additional protection, in particular by increasing the rigour of the contact resistance tests and by ensuring that the protection is maintained even under more severe conditions of assembly or use. This is particularly relevant in the automotive field, where vibrations, temperature variations, and other environmental factors can affect the strength of connector pins and connectors.

In the prior art, various solutions are used to prevent accidental contact with the connector pins. For example, it is common to install protective collars around contacts, creating insulating barriers that form physical obstacles to prevent direct contact with a human finger.

Document US2021257768A1 describes the use of an insulating member mounted by forced interlocking (“press-fit”) on the mounting portion of a flat connector, with the aim of covering certain parts of the terminal to limit the risks of direct contact. This solution is essentially based on an interlocking system, but the insulating member may remain vulnerable to undesirable movements in certain directions, in particular under the effect of vibrations. In addition, this assembly method leaves a risk of misalignment or gradual movement of the insulating member over time, which compromises the mechanical stability of the connector pin.

It is therefore desirable to propose a more robust and reliable solution, allowing to reduce the movements of the electrically insulating member in all directions, in order to improve the safety and the durability of the connector pins. Advantageously, this solution must be easily adaptable to existing connector pins, while complying with the requirements of protection standards, such as IPXXB and/or IPXXB+.

### SUMMARY OF THE INVENTION

The object of the invention is achieved with a connector pin.

According to a first aspect of the invention, the connector pin comprises a flat body elongated along an insertion direction of the connector pin. The connector pin can be inserted into a mating connector according to the insertion direction. The elongated flat body is electrically conductive. The elongated flat body comprises two contact surfaces opposed to each other. The contact surfaces are respectively connected to each other along the insertion direction by side edges. A front edge of the elongated flat body connects the side edges. The front edge comprises a flat base perpendicular to the insertion direction. A main protrusion extends from the flat base of the front edge along an insertion direction. The main protrusion comprises at least one through opening. The connector pin further comprises an electrically insulating element. The electrically insulating element covers the front edge and the main protrusion so as to fill the through opening. The electrically insulating element at least partially covers the side edges.

Thus, the arrangement of the electrically insulating element allows to meet the requirements of protection standards, such as IPXXB and/or IPXXB+. The electrically insulating element covers in particular the critical portions, in particular for compliance with safety standards, of the elongated flat body, guaranteeing a physical insulation adapted to prevent direct contact between a human finger and the electrically conductive elongated flat body of the pin.

Furthermore, the filling of the through opening with the electrically insulating element provides a reinforced grip between the latter and the elongated flat body. This allows to improve the durability of the connector pin.

This arrangement also contributes to better mechanical strength of the connector pin, in particular because the risk of movement or disengagement of the electrically insulating element is reduced.

The connector pin according to the first aspect of the present invention can be further improved by the following embodiments.

According to one embodiment, the main protrusion may have walls that extend from the flat base of the front edge in an inclined manner along the insertion direction, in particular inclined convergently in the insertion direction.

The inclined walls of the protrusion provide gripping surfaces allowing the electrically insulating element to better adhere to the metal surfaces of the elongated flat body. The inclined walls can prevent unintentional unhooking or demoulding of the electrically insulating element under the effect of mechanical forces or vibrations. Thanks to the inclined walls, a better distribution of stresses between the elongated flat metal body and the electrically insulating element, generally made of plastic, can be obtained, thus reducing the risks of plastic cracking or metal deformation. This helps to improve the durability of the connector pin.

According to one embodiment, the electrically insulating element may be integrally formed. In other words, the electrically insulating element can be designed as a single piece, without assembly of several parts.

This embodiment provides reinforced structural integrity and eliminates potential junction or weakness areas. This embodiment allows to reduce the risk of misalignment or movement of the electrically insulating element. The electrically insulating element thus obtained is made more robust.

The electrically insulating element may be made of an electrically insulating material, in particular polyamide 66 (PA66) or polybutylene terephthalate (PBT).

According to one embodiment, the electrically insulating element may be overmoulded onto the elongated flat body.

The connector pin can be obtained by a manufacturing method where an electrically insulating material is molded onto the elongated flat body. This manufacturing method differs from so-called “press-fit” assembly methods, such as interlocking, in particular forced interlocking or interlocking by pressing. The overmolding provides a strong attachment between the electrically insulating element and the elongated flat body, without the need for additional fasteners and/or assembling elements together. The overmoulding allows to fully cover the critical portions, in particular for compliance with safety standards, of the elongated flat body, guaranteeing physical insulation adapted to prevent direct contact between a human finger and the electrically conductive elongated flat body of the pin. The overmolding also improves mechanical stability by preventing relative movement between the elongated flat body and the electrically insulating element.

According to one embodiment, a maximum thickness of the main protrusion may be strictly less than a maximum thickness between the two contact surfaces, the thicknesses being respectively defined along a direction perpendicular to the insertion direction.

This difference in thickness creates a bearing surface on the flat base of the front edge of the elongated flat body, surface which is covered by the electrically insulating element. Such a configuration promotes better adhesion of the electrically insulating element to the elongated flat body.

The maximum thickness between the two contact surfaces can be equal to or less than 5 millimeters, in particular equal to or less than 2 millimeters.

According to one embodiment, the electrically insulating element may be flush with each of the surfaces of the elongate flat body. In particular, the electrically insulating element may be flush with each of the contact surfaces of the elongate flat body. The electrically insulating element may be flush with each of the side edges of the elongate flat body that are not covered by an electrically insulating element.

This configuration allows to maintain the overall shape of the connector pin, which retains a substantially rectangular shape. Geometric continuity between the electrically insulating element and the contact surfaces and the rest of the side walls is achieved, minimising asperities and facilitating insertion and removal of the pin into a mating plug or connector. In addition, this configuration reduces the risk of snagging or misalignment without altering the external dimensions of the connector pin. This also ensures improved compatibility with existing mating connectors and plugs.

According to one embodiment, the main protrusion may have at least one trapezoidal section in a sectional plane parallel to the flat base of the front edge, in particular at least one isosceles trapezoidal section in a sectional plane parallel to the flat base of the front edge. In other words, the main protrusion may have a dovetail geometry. The dovetail shape provides mechanical locking that prevents relative movements between the electrically insulating element and the elongated flat body, thereby reinforcing the structural cohesion of the connector pin.

According to one embodiment, the main protrusion may be formed by a first protrusion and a second protrusion which are partially connected to each other by a connecting portion so as to define the through opening.

The redundancy of protrusions on the front edge allows to reinforce the mechanical stability of the connector pin. The redundancy of protrusions on the front edge also allows to increase the bearing and locking points for the electrically conductive element. Thus, the distribution of mechanical stresses over the entire structure can be improved. The connecting portion is adapted to leave enough space between the protrusions to define the through opening.

In addition to the through opening, at least one of the two protrusions, the first or the second, may comprise a recess, which may be covered by the electrically insulating element. Alternatively, or in combination, at least one of the two protrusions, the first or the second, may comprise a through orifice, distinct from the through opening, which may be filled by the electrically insulating element. The filling of the recess and/or the through orifice by the electrically insulating element provides a reinforced grip between the latter and the elongated flat body.

According to one embodiment, the first protrusion, or the second protrusion, or each of said two protrusions, may have a trapezoidal shape in a sectional plane parallel to the flat base of the front edge. In other words, each main protrusion can have a dovetail geometry. The dovetail shape provides mechanical locking that prevents relative movements between the electrically insulating element and the elongated flat body, thereby reinforcing the structural cohesion of the connector pin.

According to one embodiment, the trapezoidal shape of each of the protrusions may be defined by an isosceles trapezoid in said sectional plane parallel to the flat base of the front edge, the isosceles trapezoid defining a short side parallel to a long side in said sectional plane. The first protrusion and the second protrusion can be arranged in such a way that, in said sectional plane, each of the short sides are parallel to each other and face each other.

The arrangement of the two isosceles trapezoidal protrusions facing each other at their short side allows to create an effective mechanical locking, thus increasing the resistance to undesirable movements. This arrangement promotes a uniform distribution of mechanical stresses.

According to one embodiment, the connector pin may comprise at least one third protrusion which extends at least partially from one of the side edges, the third protrusion comprising a through opening. The electrically insulating element may at least partially cover the third protrusion so as to fill the through opening.

This configuration allows to improve the holding of the electrically insulating element along the side edges, which are stressed during the insertion and removal of the connector pin in a mating plug. Further, by filling the through opening of the third protrusion with the electrically insulating element, a better grip between the electrically insulating element and the side edge or edges of the elongated flat body is achieved. Thus, a reinforced adhesion between the electrically insulating element and the side edges of the elongated flat body is obtained.

According to one embodiment, the connector pin may comprise the main protrusion at the frontal edge and at least a third protrusion at a side edge. In this embodiment, the main protrusion is not necessarily formed by a first protrusion and a second protrusion. The third protrusion can then be described as an additional protrusion or a side protrusion.

According to one embodiment, the at least one third protrusion may have a trapezoidal shape in a sectional plane perpendicular to the insertion direction. In other words, the third protrusion may have a dovetail geometry. The dovetail shape provides mechanical locking that prevents relative movements between the electrically insulating element and the elongated flat body, thereby reinforcing the structural cohesion of the connector pin.

This configuration therefore allows to improve the holding of the electrically insulating element along the side edges, which are stressed during the insertion and removal of the connector pin in a mating plug.

According to one embodiment, the first protrusion and the second protrusion may be respectively integrally connected to the at least one third protrusion, in particular by a bevelled corner.

This configuration improves the structural integrity of the elongated flat body. The bevelled corner prevents the formation of sharp angles, which could weaken the structure by creating stress points, or risk damaging the electrically insulating element.

According to one embodiment, the through opening may define a rectangular cross-section in a plane parallel to the contact surfaces. The through opening may thus comprise four inner walls. Each inner wall of the through opening is in direct contact with the electrically insulating element. This promotes the adhesion of the electrically insulating element. A rectangular opening can distribute mechanical stresses more evenly. A rectangular opening is simple to make, especially using standard manufacturing methods.

According to a second aspect of the invention, the connector pin may comprise an elongated flat body along an insertion direction of the connector pin, the elongated flat body can be electrically conductive, the elongated flat body can comprise two contact surfaces opposite each other, the contact surfaces can be respectively connected to each other along the insertion direction by side edges, a front edge of the elongated flat body can connect the side edges, the front edge can comprise a flat base and perpendicular to the insertion direction, a first protrusion can extend from the flat base of the front edge, and the first protrusion can have a trapezoidal shape in a sectional plane parallel to the flat base of the front edge, in particular an isosceles trapezoidal shape in a sectional plane parallel to the flat base of the front edge. The connector pin may further comprise an electrically insulating element. The electrically insulating element may cover the front edge and the first protrusion. In particular, the electrically insulating element may cover the entire front edge and the first protrusion. The electrically insulating element may at least partially cover the side edges.

Thus, the arrangement of the electrically insulating element allows to meet the requirements of protection standards, such as IPXXB and/or IPXXB+. The electrically insulating element covers in particular the critical portions, in particular for compliance with safety standards, of the elongated flat body, guaranteeing a physical insulation adapted to prevent direct contact between a human finger and the electrically conductive elongated flat body of the pin. The characteristic of the first protrusion, in particular its specific shape and position on the front edge of the pin, allows to reduce the movement of the electrically conductive element relative to the elongated flat body, which contributes to improving the mechanical stability of the connector pin. In addition, the dovetail connection provided by this trapezoidal protrusion on the front edge offers a more secure mechanical locking, limiting undesirable movements in several directions, i.e. not only in the insertion direction, in particular under the effect of vibrations. This reinforces the hold between the electrically conductive element and the elongated flat body, thus reducing the risk of misalignment or disengagement of the connector.

The connector pin according to the second aspect of the present invention can be further improved by the following embodiments.

According to one embodiment, a second protrusion may extend from the flat base of the front edge, and the second protrusion may have a trapezoidal shape in said sectional plane parallel to the flat base of the front edge.

The redundancy of the protrusions on the front edge allows to reinforce the mechanical stability of the connector pin. By multiplying the bearing and locking points for the electrically conductive element, the distribution of mechanical stresses over the entire structure can be improved.

According to one embodiment, each of the protrusions may have the shape of an isosceles trapezoid in said sectional plane parallel to the flat base of the front edge, the isosceles trapezoid defining a short side parallel to a long side in said sectional plane, and the first protrusion and the second protrusion may be arranged in such a way that, in said sectional plane, each of the short sides is parallel to each other and faces each other.

The arrangement of the two isosceles trapezoidal protrusions facing each other at their short side allows to create an effective mechanical locking, thus increasing the resistance to undesirable movements. This arrangement promotes a uniform distribution of mechanical stresses. It also leaves enough space between and around the protrusions to allow the electrically insulating element to come into direct contact with the flat base of the front edge, promoting adhesion of the electrically insulating element.

According to one embodiment, the first protrusion and the second protrusion may be distinct from each other in each sectional plane parallel to the flat base of the front edge.

This allows the electrically insulating element to benefit from a larger bearing surface directly in contact with the flat base of the front edge. This can increase the adhesion between the electrically insulating element, generally made of plastic, and the elongated and metallic flat body.

According to one embodiment, the first protrusion and the second protrusion may be joined together at their respective short sides in at least one sectional plane parallel to the flat base of the front edge, in particular in each sectional plane parallel to the flat base of the front edge.

This allows to create a stronger protrusion structure, which helps to improve the durability of the connector pin.

According to one embodiment, the first protrusion and the second protrusion may extend from the flat base of the front edge, in a single block, to a free end of the protrusions, and the block may be provided with an opening, in particular a through opening, which extends in a direction perpendicular to the insertion direction. The structure formed in a single block with a through opening allows to obtain increased rigidity and better mechanical stability. This opening is filled with the electrically insulating element, providing a better grip between the electrically insulating element and the elongated flat body.

The first protrusion, particularly the first and the second protrusions, may have a dovetail geometry. The dovetail shape provides mechanical locking that prevents relative movements between the electrically insulating element and the elongated flat body, thereby reinforcing the structural cohesion of the connector pin. According to one embodiment, the first protrusion, in particular the first and second protrusions, may extend from the flat base of the front edge so that its walls are inclined, in particular inclined convergently in the insertion direction.

The inclined walls provide additional gripping surfaces allowing the electrically insulating element to better adhere to the metal surfaces of the elongated flat body. This prevents unintentional unhooking or unmolding of the electrically insulating element under the effect of mechanical forces or vibrations. Thanks to the inclined walls, a better distribution of stresses between the elongated and metallic flat body and the electrically insulating element, generally made of plastic, can be obtained, thus reducing the risks of plastic cracking or metal deformation. This improves its durability.

According to one embodiment, a third protrusion may extend at least partially from the side edge or edges, and the third protrusion may have a trapezoidal shape in a sectional plane perpendicular to the insertion direction.

This configuration allows to improve the holding of the electrically insulating element along the side edges, which are stressed during the insertion and removal of the connector pin in a mating plug.

According to one embodiment, an opening, in particular a through opening or a notch, may be formed between the third protrusion and a base of the or each side edge, and the opening may extend in a direction perpendicular to the insertion direction.

By filling this opening with the electrically insulating element, a better grip between the electrically insulating element and the side edge or edges of the elongated flat body is achieved. Thus, a reinforced adhesion between the electrically insulating element and the side edges of the elongated flat body is obtained.

According to one embodiment, the first protrusion, in particular each protrusion, may be formed recessed from the flat base of the front edge, in particular recessed from the flat base of the front edge and from a base of each side edge.

This arrangement creates a bearing surface on each edge of the elongated flat body, thus allowing better adhesion of the electrically insulating element.

According to one embodiment, the first protrusion and the second protrusion may be respectively integrally connected to the third protrusion of each side edge, in particular by a bevelled corner.

This configuration improves the structural integrity of the elongated flat body. The bevelled corner prevents the formation of sharp angles, which could weaken the structure by creating stress points, or risk damaging the electrically insulating element.

According to one embodiment, the electrically insulating element may be formed in a single piece. In other words, the electrically insulating element can be designed as a single piece, without assembly of several parts. This embodiment provides reinforced structural integrity and eliminates potential junction or weakness areas. This embodiment allows to reduce the risk of misalignment or movement of the electrically insulating element. The electrically insulating element thus obtained is made more robust.

The electrically insulating element may be made of an electrically insulating material, in particular polyamide 66 (PA66) or polybutylene terephthalate (PBT).

According to one embodiment, the electrically insulating element may be overmoulded onto the elongated flat body.

The connector pin can be obtained by a manufacturing method where an electrically insulating material is molded onto the elongated flat body. This manufacturing method differs from so-called “press-fit” assembly methods, such as interlocking, in particular forced interlocking or interlocking by pressing.
The overmolding provides a strong attachment between the electrically insulating element and the elongated flat body, without the need for additional fasteners and/or assembling elements together. The overmoulding allows to fully cover the critical portions, in particular for compliance with safety standards, of the elongated flat body, guaranteeing physical insulation adapted to prevent direct contact between a human finger and the electrically conductive elongated flat body of the pin. The overmolding also improves mechanical stability by preventing relative movement between the elongated flat body and the electrically insulating element.

According to one embodiment, the electrically insulating element may be flush with each of the surfaces of the elongate flat body. In particular, the electrically insulating element may be flush with each of the contact surfaces. The electrically insulating element may be flush with each of the side edges of the elongated flat body that are not covered by an electrically insulating element.

This configuration allows to maintain the overall shape of the connector pin, which retains a substantially rectangular shape. Geometric continuity between the electrically insulating element and the contact surfaces and the rest of the side walls is achieved, minimising asperities and facilitating insertion and removal of the pin into a mating plug. In addition, this configuration reduces the risk of snagging or misalignment, while optimising mechanical stability without altering the external dimensions of the connector pin. This also ensures improved compatibility with existing mating connectors and plugs.

The aim of the present invention is also achieved with a connector element. The connector element comprises a housing and a connector pin according to the first aspect of the invention or the second aspect of the invention, wherein: the housing comprises a base, the base is provided with an opening, the connector pin is inserted into the opening of the housing base, in particular inserted in a direction opposite to the insertion direction of the pin with a mating connector or plug, such that the electrically insulating element of the connector pin extends to the housing base.

The fact that the connector pin is inserted into the opening of the housing base, and that the electrically insulating element extends to the housing base, allows to ensure continuity of insulation between the pin and the housing. This configuration allows to reduce the risk of accidental contact with a conductive part of the connector pin.

One or more features of the connector pin according to the first aspect, or respectively according to the second aspect, may be integrated or combined with the connector pin according to the second aspect, or respectively according to the first aspect.

The drawings accompanying the invention are incorporated into and form an integral part of the description to illustrate an embodiment of the present invention. These drawings, together with their description, serve to explain the principles of the invention. The sole purpose of the drawings is to illustrate the preferred and alternative examples of ways in which the invention may be embodied and used, and should not be interpreted as limiting the invention to the only embodiment illustrated and described.

The examples and variants described can therefore be considered individually or in an arbitrary combination.

### BRIEF DESCRIPTION OF THE DRAWINGS

Other features and advantages will become apparent from the more precise description following the various embodiments of the invention, as illustrated in the attached drawings, in which similar references refer to similar elements, and where:

FIG. 1 represents a connector pin according to one embodiment of the present invention.

FIG. 2 represents an exploded view of the connector pin shown in FIG. 1.

FIG. 3 shows an enlargement of the front edge of the elongated flat body of FIG. 2.

FIG. 4 shows an enlargement of a side edge of the elongated flat body of FIG. 2.

FIG. 5 represents a sectional view of the connector pin shown in FIG. 1 at the front edge.

FIG. 6 represents a cross-section of the first and second protrusions of the connector pin of FIG. 1.

FIG. 7 represents a cross-section of the third protrusions of the connector pin of FIG. 1.

FIG. 8 represents a connector element comprising a connector pin as illustrated in FIG. 1.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

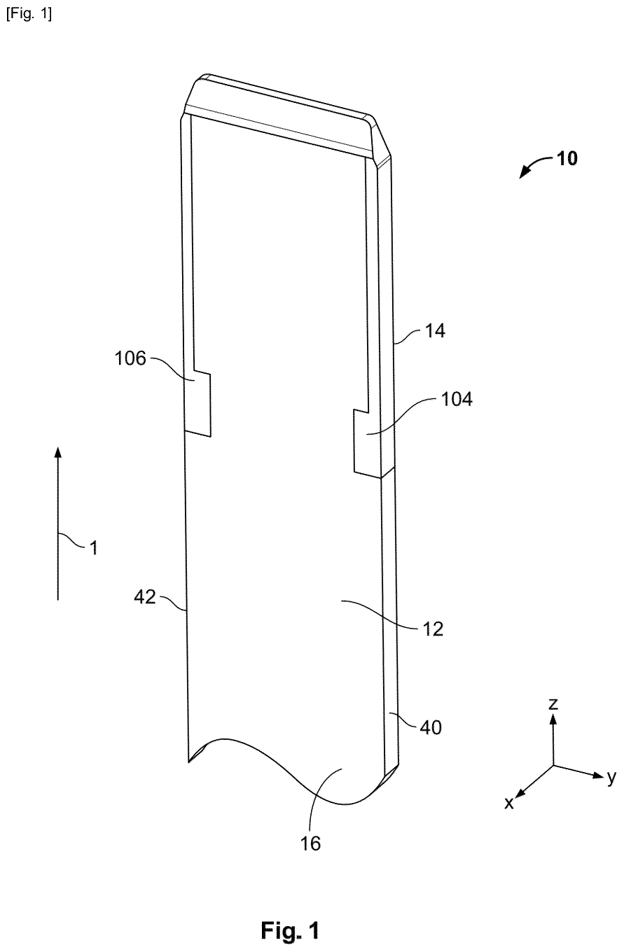

FIG. 1 represents a connector pin 10 according to one embodiment. The connector pin 10 extends in directions schematised by X, Y and Z axes which together define a Cartesian coordinate system (X, Y, Z).

The connector pin 10 comprises an elongated flat body 12. The elongated flat body 12 is elongated along an insertion direction 1, parallel to the Z axis. The connector pin 10 is configured to be connected to a mating plug (not shown) in the insertion direction 1. The elongated body 12 is electrically conductive. The elongated flat body 12 is metallic. In particular, the elongated flat body 12 is made of a copper alloy.

The connector pin 10 further comprises an electrically insulating element 14. The electrically insulating element 14 partially covers the elongated flat body 12, in particular to meet the IPXXB and/or IPXXB+ standards, providing that the elongated flat body 12 is protected against contact with a human finger. The electrically insulating element 14 may be made of an electrically insulating material, in particular polyamide 66 (PA66) or polybutylene terephthalate (PBT).

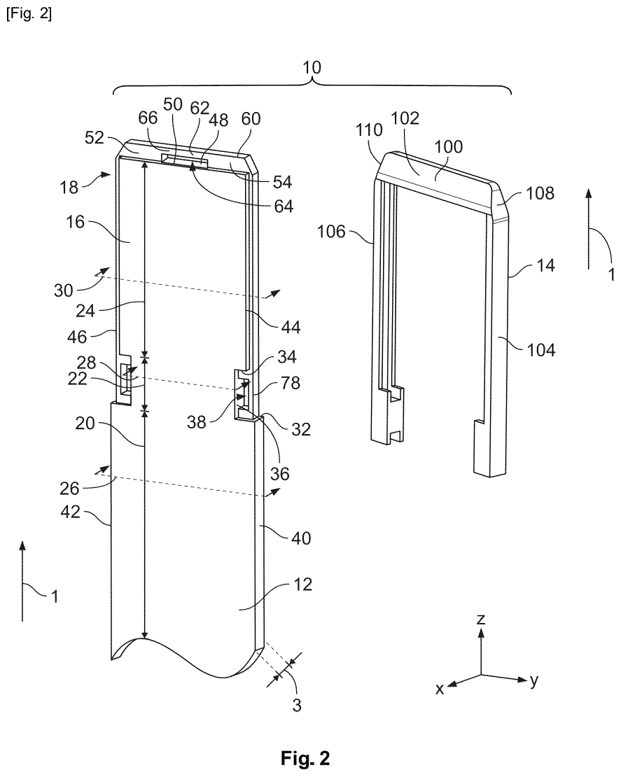

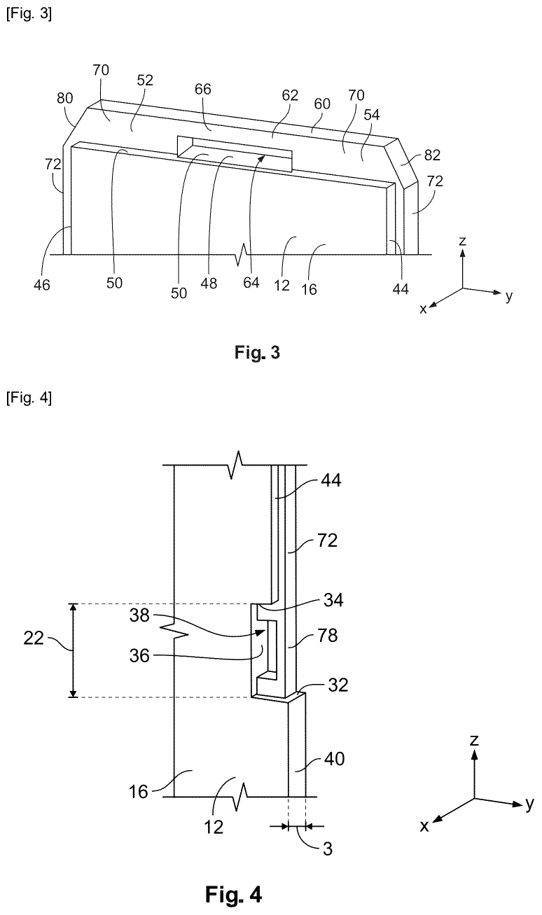

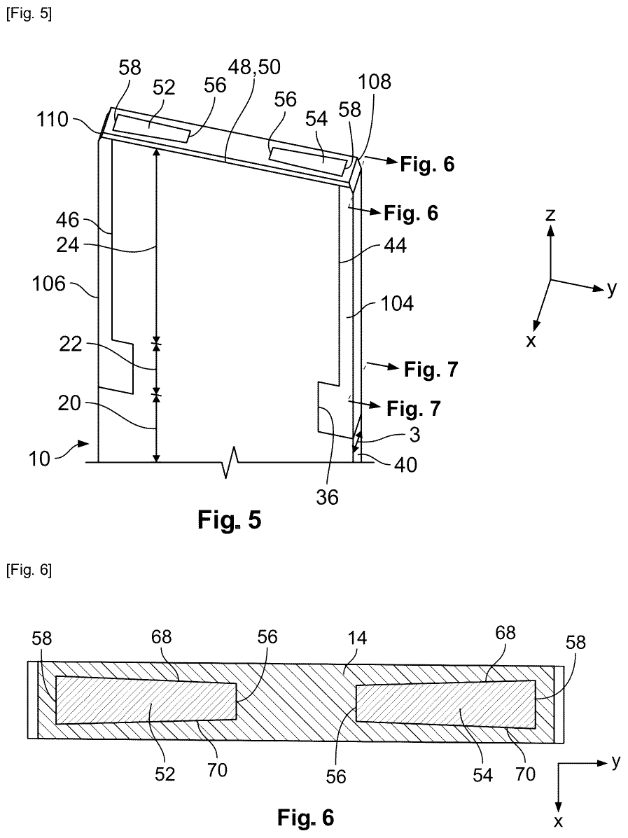

The structure of the elongated flat body 12 and the electrically conductive element 14 will be described further with reference to FIG. 2 which shows an exploded view of the connector pin 10, FIG. 3 which shows an enlargement of the front edge of the elongated flat body 12, FIG. 4 which shows an enlargement of a side edge of the elongated body 12, and FIGS. 5, 6 and 7 which show cross-sections of the connector pin in a sectional plane that is perpendicular to the insertion direction 1.

With reference to FIG. 2, the elongated flat body 12 comprises two contact surfaces 16, 18 respectively flat and opposite to each other by a thickness 3 along the X axis. Only the contact surface 16 is visible in the Figures due to the orientation of the connector pin 10 in the drawings.

Along the insertion direction 1, each of the contact surfaces 16, 18 successively comprises a first portion 20, a second portion 22 and a third portion 24. The first portion 20 is adapted to be connected to a connector body or nested in a socket (see FIG. 8). The third portion 24 extends to a free end of the elongated flat body 12. Each portion 20, 22, 24 has the same thickness, namely the thickness 3, defined along the X axis.

Each portion 20, 22, 24 has a length defined along the insertion direction 1, in other words along the Z axis. The first portion 20 has a length equal to or greater than that of the third portion 24, in particular between 1 and 1.5 times the length of the third portion 24. The second portion 22 has a length smaller than each of the lengths of the first portion 20 and the third portion 24, in particular between 3 and 8 times smaller, more in particular between 4 and 5 times smaller.

As annotated in FIG. 2, a cross-section 26 of the first portion 20 in a sectional plane (XY) has a larger area than a cross-section 30 of the third portion 24 in a parallel sectional plane (XY). A cross section 28 of the second portion 22 in a sectional plane (XY) has a smaller area than each of the cross-section 26 and the cross-section 30.

The difference in surface area between the cross-sections 26, 28, 30 is due to the geometry of the different portions 20, 22, and 24. The second portion 22 is formed by a narrowing of the first portion 20 and the third portion 24 is wider than the second portion 22, but not as wide as the first portion 20. Because of these dimensional differences, a first shoulder 32 (see in a plane (XY)) is formed between the first portion 20 and the second portion 22 and a second shoulder 34 (see in a plane (XY)) is formed between the second portion 22 and the third portion 24. The first shoulder 32 and the second shoulder 34 are spaced apart by the length of the second portion 22. This results in a notch 38 of rectangular shape in a plane (YZ).

In the embodiment shown, the connector pin 10 is symmetrical, in particular by mirror symmetry with respect to a plane (XZ). The elongated flat body 12 thus comprises two notches 38 arranged symmetrically with respect to each other. The present description of one notch 38 therefore applies to the other.

In another embodiment not shown, the connector pin could be provided with a single notch or at least three notches. The notches could be arranged at different heights relative to each other along the insertion direction 1.

At the first portion 22, the two contact surfaces 16, 18 are connected to each other by side walls 40, 42. At the second portion 24, the two contact surfaces 16, 18 are respectively connected to each other by the bearing surfaces 36. At the third portion 26, the two contact surfaces 16, 18 are connected to each other by side edges 44, 46.

The side edges 44, 46 of the third portion 26 are connected by a front edge 48. The front edge 48 comprises a flat base 50 perpendicular to the insertion direction 1. In other words, the front edge 48 extends in a plane (XY). The angle between the front edge 48 and each of the side edges 44, 46 is between 80° and 100°, in particular the angle is 90°.

As illustrated in FIG. 2 and the sectional views in FIGS. 5 and 6, a first protrusion 52 and a second protrusion 54 extend from the base 50 of the front edge 48. In the plane of the flat base 50, the first protrusion 52 is distinct from the second protrusion 54.

In the embodiment shown, the first protrusion 52 and the second protrusion 54 are symmetrical, in particular with respect to a mirror plane (plane (XZ)).

The first protrusion 52 and the second protrusion 54 each have a trapezoidal shape in a sectional plane (XY) parallel to the flat base 50 of the front edge 52. Such a sectional plane is illustrated by FIGS. 5 and 6.

The first protrusion 52 and the second protrusion 54 are respectively arranged on the flat base 50 equidistant from the contact surfaces 16, 18. The first protrusion 52 is arranged with the same distance from the side edge 46 as the second protrusion 54 from the side edge 44.

In particular, the first protrusion 52 and the second protrusion 54 have the shape of an isosceles trapezoid. Each isosceles trapezoid defines a short side 56 parallel to a long side 58 in said sectional plane. The protrusions 52, 54 are arranged such that each side 56, 58 extends parallel to the thickness 3 of the elongated flat body 12. Each long side 58 is smaller than the thickness 3 of the elongated flat body 12. Logically, each short side 56 is also smaller than the thickness 3 of the elongated flat body 12.

The first protrusion 52 and the second protrusion 54 are arranged in such a way that, in said sectional plane (see FIG. 6), each of the short sides 56 are parallel to each other and face each other. The long side 58 of the first protrusion 52 is oriented towards the side edge 46. The long side 58 of the second protrusion 54 faces the side edge 44.

In the embodiment shown, see in particular in FIG. 2, the first protrusion 52 and the second protrusion 54 extend from the flat base 50 of the front edge 52 in a single block 62 to a free end 60 common to the two protrusions 52, 54. In particular, the end 60 is formed by a flat surface (60) which extends parallel to the flat base 50 (see FIG. 2 and FIG. 3). The block 62 forms a main protrusion 62. The block 62, in other words the main protrusion 62, is provided with an opening 64. In particular, the opening 64 is a through opening 64. The through opening 64 extends in a direction perpendicular to the insertion direction 1 so as to pass through the block 62, in other words the main protrusion 62, on either side. The block 62, in other words the main protrusion 62, is formed continuously by a connecting portion 66 which partially connects the first protrusion 52 and the second portion 54. This connecting portion 66 connects the respective short sides 56 of the trapezoidal shapes of the protrusions 52, 54. This connecting portion 66, such as a bridge, allows to define the through opening 64. The through opening 64 is formed between the flat base 50 of the front edge 48 and the connecting portion 66.

For each of the first protrusion 52 and the second protrusion 54, side walls 68, 70 connect the short side 56 to the long side 58 of the trapezoidal shapes (see FIG. 6). These walls 68, 70 may be inclined between the base 50 and the free end 60. In particular, the side walls 68 and 70 may be inclined convergently, i.e. they move towards each other starting from the base 50 towards the free end 60. In another variant, the walls 68, 70 may converge in the other direction, that is to say that they approach each other starting from the free end 60 towards the base 50. In yet another variant, the side walls 68, 70 can extend perpendicularly to the base 50.

The first protrusion 52 and the second protrusion 54 thus form a main protrusion 62 (defined by the block 62) which is recessed with respect to the contact surfaces 16, 18. The main protrusion 62 is thinner than the elongated flat body 12 of thickness 3, thus forming a narrowing along the insertion direction 1 with respect to the flat base 50 of the front edge 52. This allows to provide bearing surfaces, in particular the flat base 50, the free end 60, the side walls 68, 70 and the inside of the opening 64, for the electrically insulating element 14.

In the embodiment shown, the connector pin 10 is provided with a third protrusion 72. The third protrusion 72 extends from each side edge 44, 46.

Since the connector pin 10 is symmetrical in the embodiment shown, the following description of the third protrusion 72 that extends from the side edge 44 applies to the third protrusion 72 that extends from the side edge 46.

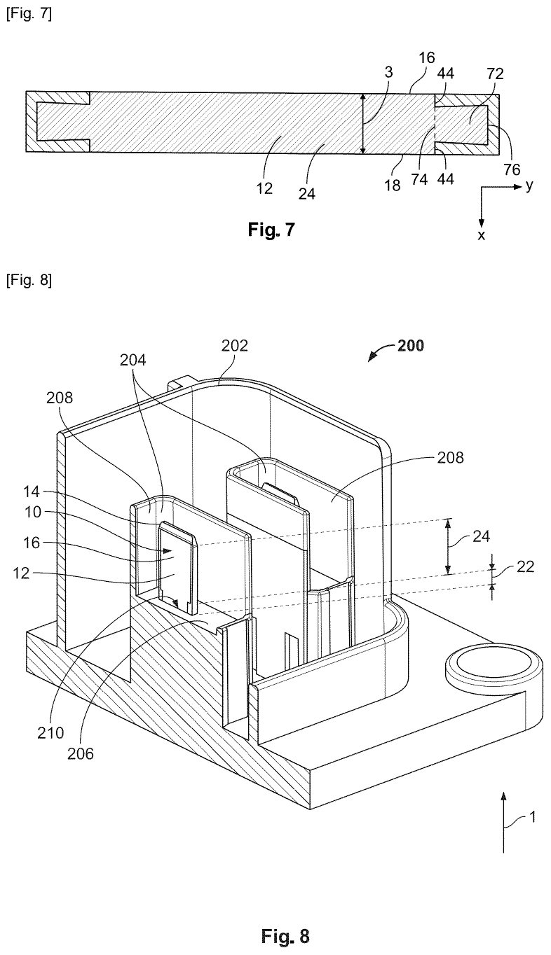

As illustrated in FIG. 7, the side edge 44 forms a flat base, in particular in the plane (XZ), from which the third protrusion 72 extends in a direction perpendicular to the insertion direction 1, i.e. parallel to the Y axis. In a sectional view (XY) perpendicular to the insertion direction 1, and as shown in FIG. 7, the third protrusion 72 has a trapezoidal cross-section. In particular, the third protrusion 72 has a cross-section that has the shape of an isosceles trapezoid. The isosceles trapezoid defines a short side 74 parallel to a long side 76 in the sectional plane (XY) illustrated in FIG. 7. The short side 74 is flush with the side edge 44 (this is why it is diagrammatically shown in dotted lines in FIG. 7). In other words, the third protrusion 72 extends from the side edge 44 of its short side 74 toward its long side 76. The long side 76 thus forms the free end (76) of the third protrusion 72. The third protrusion 72 extends from the side edge 44 towards its free end 76, widening progressively. The third protrusion 72 takes the shape of a dovetail.

The length of the long side 76 is less than the thickness 3 of the elongated flat body 12. As illustrated in the sectional plane of FIG. 7, the third protrusion 72 is positioned relative to the side edge 44 in a manner such as to be equidistant from the contact surfaces 16 and 18. This configuration allows to retain bearing surfaces on the side edge 44 for the electrically insulating element 14.

As illustrated in FIG. 4, at the second portion 22, the third protrusion 72 joins the first shoulder 32 to the second shoulder 34 so as to form the notch 38. The third protrusion 72 thus has a bridge-shaped connecting structure 78 at the second portion 22.

At the second portion 22, as at the third portion 24, the third protrusion 72 is positioned with respect to the side edge 44 so as to be equidistant from the contact surfaces 16 and 18. In addition, at the second portion 22, the third portion 24 protrudes from the bearing surface 36 so as to leave a portion of the bearing surface 36 on either side of the third protrusion 72. A portion of the first shoulder 32 and a portion of the second shoulder 34 are also left free so as to provide a support for the electrically insulating element 14.

This arrangement allows to improve the mechanical stability and the structural integrity of the electrically insulating element 14.

As shown in FIG. 3, the third protrusion 72 of the side edge 44 is integrally connected to the second protrusion 54, in particular by a bevelled corner 80. The third protrusion 72 of the side edge 46 is integrally connected to the first protrusion 52, in particular by a bevelled corner 82.

In the embodiment shown, the first protrusion 52, the second protrusion 54 and the third protrusion 72 of each side edge 44, 46 thus form a protrusion of a continuous block, which improves the mechanical stability of the elongated flat body 12, and therefore, of the connector pin 10.

The electrically insulating element 14 is overmolded onto the elongated flat body 12. The electrically insulating element 14 completely covers the flat base 50 of the front edge, the first protrusion 52 and the second protrusion 54. The electrically insulating element 14 completely covers the side edges 44, 46 of the third portion 24 and the third protrusion 72 at the third portion 24. The electrically insulating element 14 completely covers the bearing surfaces 36 of the second portion 22 and the third protrusion 72 on each side at the second portion 24, including the connecting structure 78. None of the first, second and third protrusions 52, 54, 72 are visible when the electrically insulating element 14 is overmolded to the elongated flat body 12, as illustrated by the connector pin 10 of FIG. 1.

The electrically insulating element 14 does not cover the contact surfaces 16, 18. The electrically insulating element 14 does not cover, even partially, the first portion 20.

The electrically insulating element 14 has an approximately “U” shape. A front portion 100 has an outer wall 102 inclined convergently towards the insertion direction 1. This facilitates the insertion of the connector pin 10 into a mating plug (not shown).

Side edges 104, 106 of the electrically insulating element 14 are respectively connected to the front portion 100 by bevelled corners 108, 110. The bevelled corners 108, 110 also facilitate insertion into a mating plug.

In a plane (YZ), in particular in the plane of each contact surface 16, 18, the side edges 104, 106 of the electrically insulating element 14 are respectively flush with the contact surfaces 16, 18. FIG. 1 illustrates that a surface of each side edge 104, 106 is in the same plane as the contact surface 16. Although the other side of the pin 10 is not visible in FIG. 1, another surface of each side edge 104, 106 is in the same plane as the contact surface 18.

In a plane (XZ), in particular in the plane of each side wall 40, 42, the side edges 104, 106 of the electrically insulating element 14 are flush with the side walls 40, 42 of the first portion 20. FIG. 1 illustrates that a surface of the side edge 104 is in the same plane as the side wall 40. Although the other side of the pin 10 is not visible in FIG. 1, a surface of the side edge 106 is in the same plane as the side wall 42.

Thus, a cross-section of the connector pin 10 at the second portion 22 and the third portion 24 is rectangular (see FIG. 7 for example) and retains the same dimensions as the cross-section of the first portion 20. In other words, the overmolding of the electrically insulating element 14 onto the portions 22, 24 does not modify the dimensions of the connector pin 10 with respect to the first portion 20. The connector pin 10 is substantially in the shape of a rectangular block.

The electrically insulating element 14 is held in the insertion direction 1, and in a direction perpendicular to the insertion direction 1, by virtue of its adhesion to the bearing surfaces, in particular formed by the flat base 50, the free end 60, the side edges 42 and 44, the first shoulder 32, the second shoulder 34 and the bearing surfaces 36. In addition, the electrically insulating element 14 is stabilised by the electrically insulating material that fills the opening 64 and the notches 38.

FIG. 8 partially illustrates a connector element 200. The connector element 200 comprises a housing 202. The housing 202 of FIG. 8 comprises two connector pin receptacles 204. The number of receptacles 204 is not limiting. Each receptacle 204 comprises a base 206. The base 206 is surrounded by a protective collar 208 which extends perpendicularly from the base 206 in the insertion direction 1. In particular, the base 206 is surrounded by a protective collar 208 in the form of the letter “U”. The base 206 comprises an opening 210 adapted to receive a connector pin 10. In FIG. 8, a connector pin 10 is inserted in the opening 210 of the base 206 of the housing 202. The connector pin 10 is inserted so that the electrically insulating element 14 of the connector pin 10 extends to the base 206 of the housing 202. In other words, the first portion 20 of the flat and elongated body 12 is inserted inside the opening 210, and is thus not visible in FIG. 8. While the second portion 22 and the third portion 24 protrude out of the opening 210. Thus, the electrically insulating element 14 is advantageously arranged on the portions 22, 24 of the connector pin 10 which are likely to be in contact with a finger.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A connector pin comprising an elongated flat body along an insertion direction of the connector pin,
the elongated flat body is electrically conductive,
the elongated flat body comprises two contact surfaces opposite each other,
the contact surfaces are respectively connected to each other along the insertion direction by side edges,
a front edge of the elongated flat body connects the side edges,
the front edge comprises a flat base perpendicular to the insertion direction,
a main protrusion extends from the flat base of the front edge along an insertion direction, and
the main protrusion comprises at least one through opening,
the connector pin further comprises an electrically insulating element,
the electrically insulating element covers the front edge and the main protrusion so as to fill the through opening, and
the electrically insulating element at least partially covers the side edges.

2. The connector pin according to claim 1, wherein the main protrusion has walls that extend from the flat base of the front edge in an inclined manner along the insertion direction.

3. The connector pin according to claim 1, wherein the electrically insulating element is integrally formed.

4. The connector pin according to claim 1, wherein the electrically insulating element is overmoulded onto the elongated flat body.

5. The connector pin according to claim 1, wherein a maximum thickness of the main protrusion is strictly less than a maximum thickness between the two contact surfaces, the thicknesses being respectively defined along a direction perpendicular to the insertion direction.

6. The connector pin according to claim 1, wherein the electrically insulating element is flush with each of the surfaces of the elongated flat body, in particular with each of the contact surfaces.

7. The connector pin according to claim 1, wherein the main protrusion has at least one trapezoidal section in a sectional plane parallel to the flat base of the front edge, in particular at least one isosceles trapezoidal section in a sectional plane parallel to the flat base of the front edge.

8. The connector pin according to claim 1, wherein the main protrusion is formed by a first protrusion and a second protrusion which are partially connected to each other by a connecting portion so as to define the through opening.

9. The connector pin according to claim 8, wherein the first protrusion, or the second protrusion, or each of said two protrusions, has a trapezoidal shape in a sectional plane parallel to the flat base of the front edge.

10. The connector pin according to claim 9, wherein the trapezoidal shape of each of the protrusions is defined by an isosceles trapezoid in said sectional plane parallel to the flat base of the front edge,
the isosceles trapezoid defining a short side parallel to a long side in said sectional plane, and
the first protrusion and the second protrusion are arranged in such a way that, in said sectional plane, each of the short sides are parallel to each other and face each other.

11. The connector pin according to claim 8, wherein the first protrusion and the second protrusion are respectively integrally connected to the at least one third protrusion, in particular by a bevelled corner.

12. The connector pin according to claim 1, wherein at least one third protrusion which extends at least partially from one of the side edges, the third protrusion comprising a through opening, and the electrically insulating element at least partially covers the third protrusion so as to fill the through opening.

13. The connector pin according to claim 12, wherein the at least one third protrusion has a trapezoidal shape in a sectional plane perpendicular to the insertion direction.

14. The connector pin according claim 13, wherein the first protrusion and the second protrusion are respectively integrally connected to the at least one third protrusion, in particular by a bevelled corner.

15. The connector pin according to claim 1, wherein the through opening delimits a rectangular cross-section in a plane parallel to the contact surfaces.

16. A connector element comprising a housing and a connector pin according to claim 1, wherein:
the housing comprises a base, the base is provided with an opening,
the connector pin is inserted into the opening of the base of the housing so that the electrically insulating element of the connector pin extends to the base of the housing.
